(19) United States
(12) Patent Application Publication
(10) Pub. No.: US 2008/0098004 A1
(43) Pub. Date: Apr. 24, 2008

(54) CLIENT SERVER SYSTEM

(75) Inventor: Masayoshi Matsuoka, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/870,970

(22) Filed: Oct. 11, 2007

(30) Foreign Application Priority Data
Oct. 18, 2006 (JP) 2006-284173

(51) Int. Cl. G06F 17/30

(52) U.S. Cl. 707/10; 707/E17.005; 707/E17.032

(57) ABSTRACT

Disclosed is a client server system including at least one server and a client terminal connected to the server, wherein
the server includes:
a first storage section to store meta-information of the contents; and
a transmission section to transmit the meta-information, and
the client terminal includes:
a second storage section to store the meta-information transmitted from the server;
a judgment information storing section to store CDS identifying information and update-related information related to updates of the meta-information;
an obtainment section to obtain CDS identifying information and update-related information of the meta-information stored in the server;
an update judging section to judge whether the meta-information has been updated or not by comparing the CDS identifying information and the update-related information whom the server and the client terminal have respectively; and
an update section to obtain updated meta-information from a server which stores the updated meta-information to update the second storage section.

### BACKGROUND OF THE INVENTION

1. Field of the Invention

The present invention relates to a client server system.

2. Description of Related Art

Conventionally, a client server system to include servers and client terminals connected to the servers through a wireless local area network (LAN) to receive contents from the servers has been known. Meta-information of the contents is generally stored in the servers, and the client terminals obtain the meta-information of the contents from the servers when they need it. A client server system provided with a management device that manages the meta-information in an integrative way has also been known (see, for example, Japanese Patent Application Laid-Open Publication No. 2005-182778).

Moreover, a client server system to judge a content to be stored on the basis of meta-information received from a server and a profile of a user has also been known (see, for example, Japanese Patent Application Laid-Open Publication No. 2002-183029).

However, in the case of obtaining meta-information from the servers when the need arises, a problem of the delay in the processing which uses the meta-information in the client terminals is caused. The problem cannot be settled only by managing the meta-information with the management device like the technique disclosed in the Japanese Patent Application Laid-Open Publication No. 2005-182778. Moreover, because the technique disclosed in the Japanese Patent Application Laid-Open Publication No. 2002-183029 receives the meta-information together with the content, the technique cannot process the meta-information before receiving the content and cannot settle the problem mentioned above.

### SUMMARY OF THE INVENTION

It is, therefore, a main object of the present invention to provide a client server system capable of processing meta-information efficiently in a client terminal.

According to a first aspect of the present invention, there is provided a client server system, comprising at least one server to store contents, and a client terminal connected to the at least one server through a wireless circuit to receive the contents from the at least one server, wherein

the at least one server includes:

a plurality of containers to store the contents;

a first storage section to store pieces of meta-information of the contents;

a container update information storing section to store container update information indicating numbers of times of updates of the containers;

a server update information storing section to store server update information indicating a number of times of updates of the at least one server;

a server identifying information storing section to store server identifying information to identify the server; and

a transmission section to transmit the pieces of the meta-information stored in the first storage section to the client terminal, and

the client terminal includes:

a second storage section to store the pieces of the meta-information transmitted by the transmission section;

a judgment information storing section to store the server identifying information, CDS identifying information to identify a CDS to manage the pieces of the meta-information of the contents of the at least one server, and the container update information and the server update information as update-related information related to updates of the meta-information managed by the CDS;

an obtainment section to obtain, at a time of power activation, the CDS identifying information related to the at least one server connected to the client terminal through the wireless circuit, the server identifying information, and the container update information and the server update information as update-related information of the pieces of the meta-information stored in the at least one server;

an update judging section to specify the CDS based upon the server identifying information and the CDS identifying information, which have been obtained by the obtainment section, to judge whether the server update information, which is managed by the specified CDS and has been obtained by the obtainment section, coincides with the server update information which has been stored in the judgment information storing section or not, to judge, when judged as not coinciding with each other, whether the container update information obtained by the obtainment section coincides with the container update information which has been stored in the judgment information storing section or not, thereby to judge whether the pieces of the meta-information have been updated or not; and

an update section to obtain updated pieces of meta-information from a server, which stores the updated pieces of the meta-information, of the at least one server to update the second storage section when the update judging section judges that the pieces of the meta-information have been updated.

According to a second aspect of the present invention, there is provided a client server system comprising at least one server to store contents, and a client terminal connected to the server through a wireless circuit to receive the contents from the at least one server, wherein

the at least one server includes:

a first storage section to store pieces of meta-information of the contents; and

a transmission section to transmit the pieces of the meta-information stored in the first storage section to the client terminal, and

the client terminal includes:

a second storage section to store the pieces of the meta-information transmitted by the transmission section;

a judgment information storing section to store CDS identifying information to identify a CDS to manage the pieces of the meta-information of the contents of the at least one server and update-related information related to updates of the pieces of the meta-information managed by the CDS;

an obtainment section to obtain, at a predetermined timing, CDS identifying information related to the at least one server connected to the client terminal through the wireless circuit and update-related information of the meta-information stored in the at least one server;

an update judging section to judge whether the pieces of the meta-information have been updated or not by comparing the CDS identifying information and the update-related information that have been obtained by the obtainment section with the CDS identifying information and the update-related information that have been stored in the judgment information storing section; and

an update section to obtain updated pieces of meta-information from a server, which stores the updated pieces of the meta-information, of the at least one server to update the second storage section when the update judging section judges that the pieces of the meta-information have been updated.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a diagram to show the schematic configuration of a client server system according to a preferred embodiment of the present invention;

FIG. 2 is a block diagram to show the configuration of a server according to the preferred embodiment of the present invention;

FIG. 3 is a diagram to illustrate the configuration of a meta-information database according to the preferred embodiment of the present invention;

FIG. 4 is a block diagram to show the configuration of a client terminal according to the preferred embodiment of the present invention; and

FIG. 5 is a flow chart to illustrate an example of a meta-information storing operation in the client terminal of the client server system according to the preferred embodiment of the present invention.

### DESCRIPTION OF THE PREFERRED EMBODIMENTS

In the following, a client server system according to preferred embodiments of the present invention will be described in detail with reference to the attached drawings.

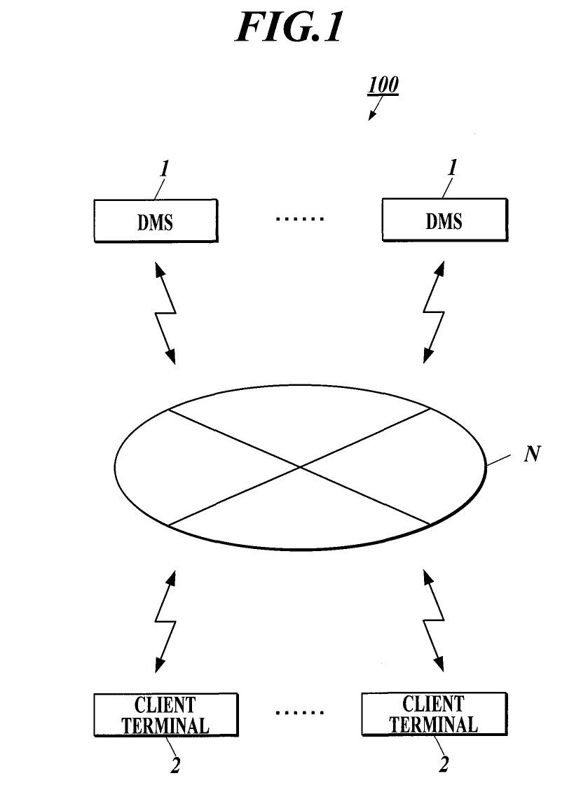

The configuration of a client server system 100 according to a preferred embodiment of the present invention is first described with reference to FIG. 1. The client server system 100 of the present embodiment includes, for example, digital media servers (DMSes) 1 as at least one server to store contents and client terminals 2 connected to the DMSes 1 through a wireless circuit N to receive the contents from the DMSes 1 as shown in the FIG. 1.

Incidentally, the numbers of the DMSes 1 and the client terminals 2, which are connected with the wireless circuit N, are not limited to the ones shown in the FIG. 1, but the numbers are arbitrary.

The wireless circuit N is a network such as a wireless local area network (LAN) in conformity with, for example, Bluetooth Standard, Institute of Electrical and Electronic Engineers (IEEE) 802.11 Standard, or the like.

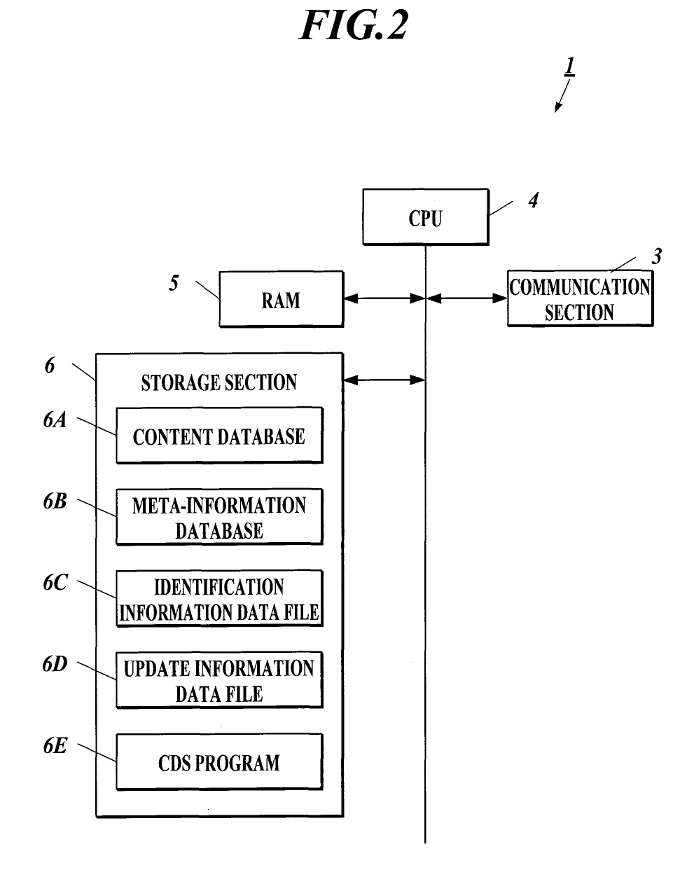

Each of the DMSes 1 includes, for example, a communication section 3, a central processing unit (CPU) 4, a random access memory (RAM) 5, a storage section 6, and the like, as shown in FIG. 2.

The communication section 3 performs the transmission and the reception of predetermined communication data with the client terminals 2 through, for example, the wireless circuit N.

To put it concretely, the communication section 3 is provided with, for example, a radio antenna (not shown), a mixer (not shown), and the like, and performs predetermined processing to contents in accordance with a control signal from the CPU 4 to transmit the processed contents to the client terminals 2 with the radio antenna.

Moreover, the communication section 3 transmits meta-information stored in a meta-information database 6B, which will be described later, to the client terminals 2 through the wireless circuit N, and functions as a transmission section.

The CPU 4 reads, for example, a processing program stored in the storage section 6 and the like, and expands the read program in the RAM 5 to execute the expanded program. The CPU 4 thereby performs the control of the whole DMS 1.

The RAM 5 expands the processing program and the like executed by the CPU 4 into a program storing area in the RAM 5, and stores input data, the processing results and the like that have been produced when the processing program has been executed into a data storing area.

The storage section 6 includes a storage medium (not shown), in which, for example, programs, data, and the like are previously stored, and the storage medium is composed of, for example, a semiconductor memory and the like. Moreover, the storage section 6 stores various kinds of data and various processing programs for enabling the CPU 4 to realize the function of controlling the whole DMS 1, the data processed by the execution of the programs, and the like. To put it more concretely, the storage section 6 stores, for example, a content database 6A, the meta-information database 6B, an identification information data file 6C, an update information data file 6D, a CDS program 6E, and the like, as shown in FIG. 2.

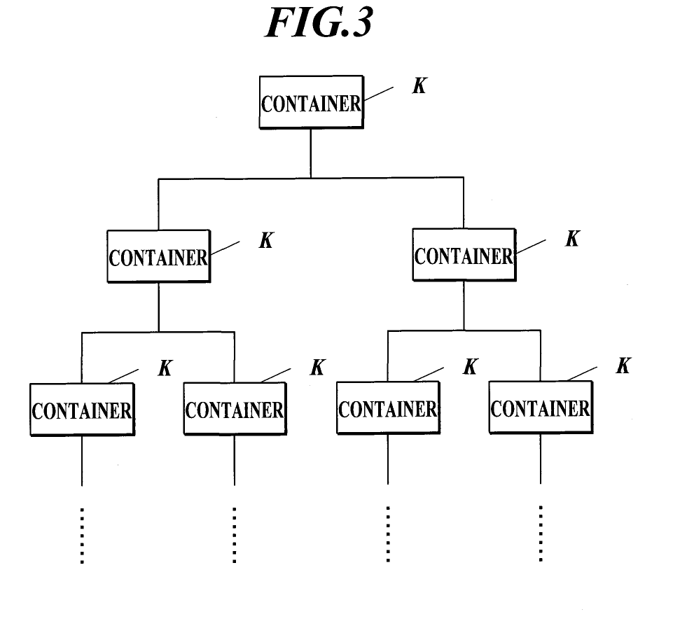

The content database 6A stores, for example, the contents to be transmitted to the client terminals 2. Moreover, the content database 6A is stored in, for example, containers K arranged in a hierarchical structure in the storage section 6 as shown in FIG. 3.

The meta-information database 6B stores, for example, the pieces of meta-information of the contents. The storage section 6 functions as a first storage section by storing such the meta-information database 6B.

The identification information data file 6C stores, for example, a universally unique identifier (UUID) (specified in the unique device name (UDN) element) as the server identifying information for identifying the DMS 1, and a UUID (UDN) as the CDS identifying information for identifying the CDS program 6E equipped in the DMS 1. The storage section 6 functions as a server identifying information storing section by storing such the identification information data file 6C.

The update information data file 6D stores, for example, a system update ID as server update information to indicate the number of times of updates of the DMS 1, and a container update ID as the container update information to indicate the numbers of times of the updates of the containers K. The storage section 6 functions as a server update information storing section and a container update information storing section by storing such the update information data file 6D.

The CDS program 6E is a program to enable the CPU 4 to realize, for example, the function of managing the pieces of meta-information of the contents stored in the DMS 1.

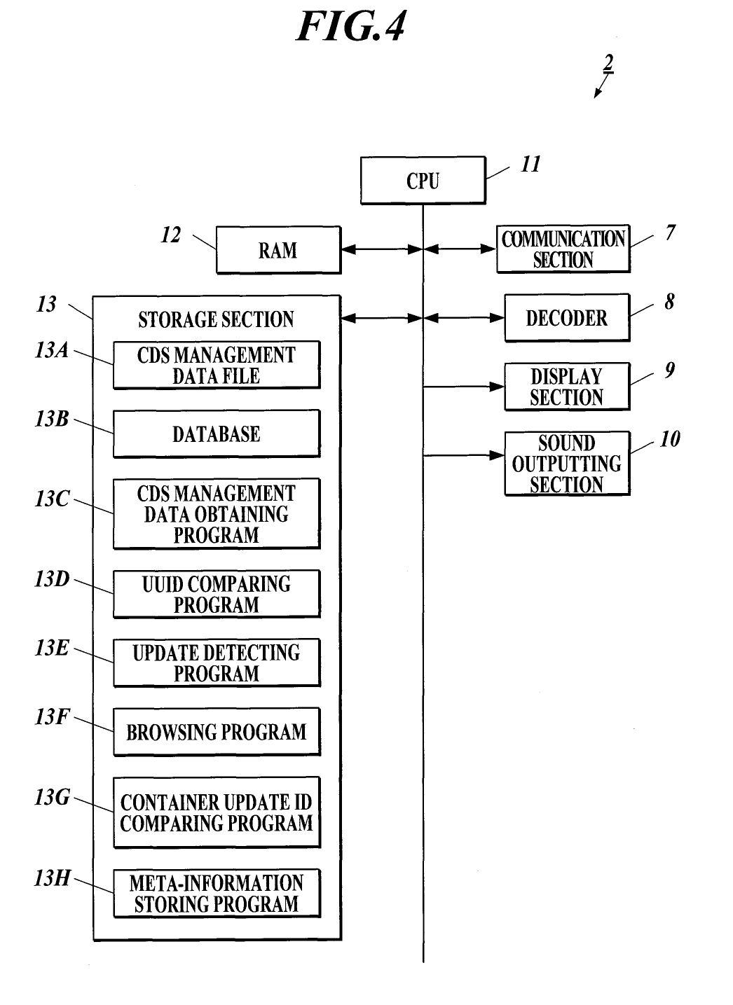

Each of the client terminals 2 includes, for example, a communication section 7, a decoder 8, a display section 9, a sound outputting section 10, a CPU 11, a RAM 12, a storage section 13, and the like, as shown in FIG. 4.

The communication section 7, for example, performs the transmission and the reception of predetermined communication data with the DMSes 1 through the wireless circuit N.

To put it concretely, the communication section 7 is provided with, for example, a radio antenna (not shown) and a mixer (not shown), and performs the predetermined processing to the data transmitted from the DMSes 1 through the radio antenna to output the processed data to the decoder 8.

Moreover, the communication section 7 controls the radio antenna to receive the meta-information transmitted from the DMSes 1.

The decoder 8 decodes the contents transmitted from the DMSes 1 in accordance with, for example, a control signal input from the CPU 11 to generate image data and sound data, and outputs the generated image data and the generated sound data to the display section 9 and the sound outputting section 10, respectively.

The display section 9 is composed of, for example, a liquid crystal display (LCD), a Plasma Display Panel (PDP), or the like, and displays an image based on the image data output from the decoder 8.

The sound outputting section 10 is composed of, for example, a speaker and the like, and outputs a sound based on the sound data output from the decoder 8.

The CPU 11 performs the control of the whole client terminal 2 by reading, for example, a processing program stored in the storage section 13 and expanding the read program into the RAM 12 to execute the program.

The RAM 12 expands the processing program and the like, which are to be executed by the CPU 11, into the program storing area in the RAM 12, and stores input data, processing results produced at the time of the execution of the processing program, and the like, into the data storing area in the RAM 12.

The storage section 13 includes, for example, a storage medium (not shown), in which programs, data, and the like, are previously stored, and the storage medium is composed of, for example, a semiconductor memory. Moreover, the storage section 13 stores various kinds of data and various processing programs for enabling the CPU 11 to realize the function of controlling the whole client terminal 2, the data processed by the execution of the programs, and the like. To put it more concretely, the storage section 13 stores, for example, as shown in FIG. 4, a CDS management data file 13A, a database 13B, a CDS management data obtaining program 13C, a UUID comparing program 13D, an update detecting program 13E, a browsing program 13F, a container update ID comparing program 13G, a meta-information storing program 13H, and the like.

The CDS management data file 13A stores, for example, the UUIDs of the DMSes 1, the UUIDs of the CDS programs 6E, the system update IDs, and the container update IDs. The storage section 13 functions as a judgment information storing section by storing such the CDS management data file 13A.

The database 13B stores, for example, the contents transmitted from the DMSes 1, and the meta-information of the content. The storage section 13 functions as a second storage section by storing such the database 13B.

The CDS management data obtaining program 13C is a program to enable the CPU 11 to realize the function of obtaining the UUIDs of the DMSes 1 connected to the client terminal 2 through the wireless circuit N, the UUIDs of the CDS programs 6E to manage the meta-information stored in the DMSes 1, the system update IDs, and the container update IDs from the DMSes 1 to store them into the RAM 12 temporarily, for example, at the time of power activation. The CPU 11 functions as an obtainment section by executing such the CDS management data obtaining program 13C.

The UUID comparing program 13D is, for example, a program to enable the CPU 11 to realize the function of judging whether the UUIDs of the DMSes 1 and the UUIDs of the CDS programs 6E that have been obtained by the execution of the CDS management data obtaining program 13C coincide with the UUIDs of the DMSes 1 and the UUIDs of the CDS programs 6E that are stored in the CDS management data file 13A or not, respectively.

The coincidences of the UUIDs of the DMSes 1 and the UUIDs of the CDS programs 6E that have been obtained by the execution of the CDS management data obtaining program 13C with the UUIDs of the DMSes 1 and the UUIDs of the CDS programs 6E that are stored in the CDS management data file 13A, respectively, here indicate that no new DMSes 1 and no new CDS programs 6E are provided in the wireless circuit N, and the noncoincidences between them indicate that new DMSes 1 and/or new CDS programs 6E are provided in the wireless circuit N.

The update detecting program 13E is, for example, a program to enable the CPU 11 to realize the following judging function when the CPU 11 judges that the UUIDs of the DMSes 1 and the UUIDs of the CDS programs 6E that have been obtained by the execution of the CDS management data obtaining program 13C coincide with the UUIDs of the DMSes 1 and the UUIDs of the CDS programs 6E that are stored in the CDS management data file 13A, respectively, by executing the UUID comparing program 13D. The judging function judges whether the system update IDs that are managed by the CDS programs 6E identified by the UUIDs and have been obtained from the DMSes 1 identified by the UUIDs coincide with the system update IDs stored in the CDS management data file 13A or not.

The coincidence of the system update ID obtained from the DMS 1 and the system update ID stored in the CDS management data file 13A indicates that the DMS 1 has not been updated, and the noncoincidence between them indicates that the DMS 1 has been updated. The browsing program 13F is a program to enable the CPU 11 to realize, for example, the following function of obtaining meta-information when the CPU 11 judges that the UUID of the DMS 1 and the UUID of the CDS program 6E that have been obtained by executing the CDS management data obtaining program 13C do not coincide with the UUID of the DMS 1 and the UUID of the CDS program 6E that are stored in the CDS management data file 13A, respectively, by executing the UUID comparing program 13D, and when the CPU 11 judges that the system update ID obtained from the DMS 1 do not coincide with the system update ID stored in the CDS management data file 13A by executing the update detecting program 13E. The function judges whether the container update IDs are stored in the DMS 1 or not (that is, whether the container update IDs of the DMS 1 have been obtained by the execution of the CDS management data obtaining program 13C or not), and obtains the pieces of meta-information by performing CDS browsing of the DMS 1 when the function judges that the container update IDs are not stored in the DMS 1.

The container update ID comparing program 13G is a program to enable the CPU 11 to realize, for example, the following judging function when the CPU 11 judges that the container update IDs are stored in the DMS 1 by executing the browsing program 13F. The function judges whether the container update IDs obtained by executing the CDS management data obtaining program 13C coincide with the container update IDs stored in the CDS management data file 13A or not.

The coincidence of the container update IDs obtained by executing the CDS management data obtaining program 13C and the container update IDs stored in the CDS management data file 13A indicates that the content in the containers K has not been updated, and the noncoincidence between them indicates that the contents in the containers K have been updated.

The CPU 11 then functions as an update judging section by executing the UUID comparing program 13D, the update detecting program 13E, the browsing program 13F, and the container update ID comparing program 13G.

The meta-information storing program 13H is a program to enable the CPU 11 to realize, for example, the following function of updating the database 13B when the CPU 11 judges that the container update IDs obtained by executing the CDS management data obtaining program 13C do not coincide with the container update IDs stored in the CDS management data file 13A by executing the container update ID comparing program 13G, that is, when the CPU 11 judges that the content in the containers K has been updated. At that time, the function updates the CDS management data file 13A on the basis of the UUID of the DMS 1 after updates, the UUIDs of the CDS programs 6E after updates, the system update ID, and the container update IDs, and obtains the updated meta-information from the DMS 1. The function thereby updates the database 13B.

Moreover, the meta-information storing program 13H is a program to enable the CPU 11 to realize the function of updating the CDS management data file 13A on the basis of, for example, the UUID of the DMS 1 after update, the UUID of the CDS program 6E after update, the system update ID, and the container update ID, and of updating the database 13B on the basis of the meta-information obtained by executing the browsing program 13F.

The CPU 11 functions as an update section by executing such the meta-information storing program 13H.

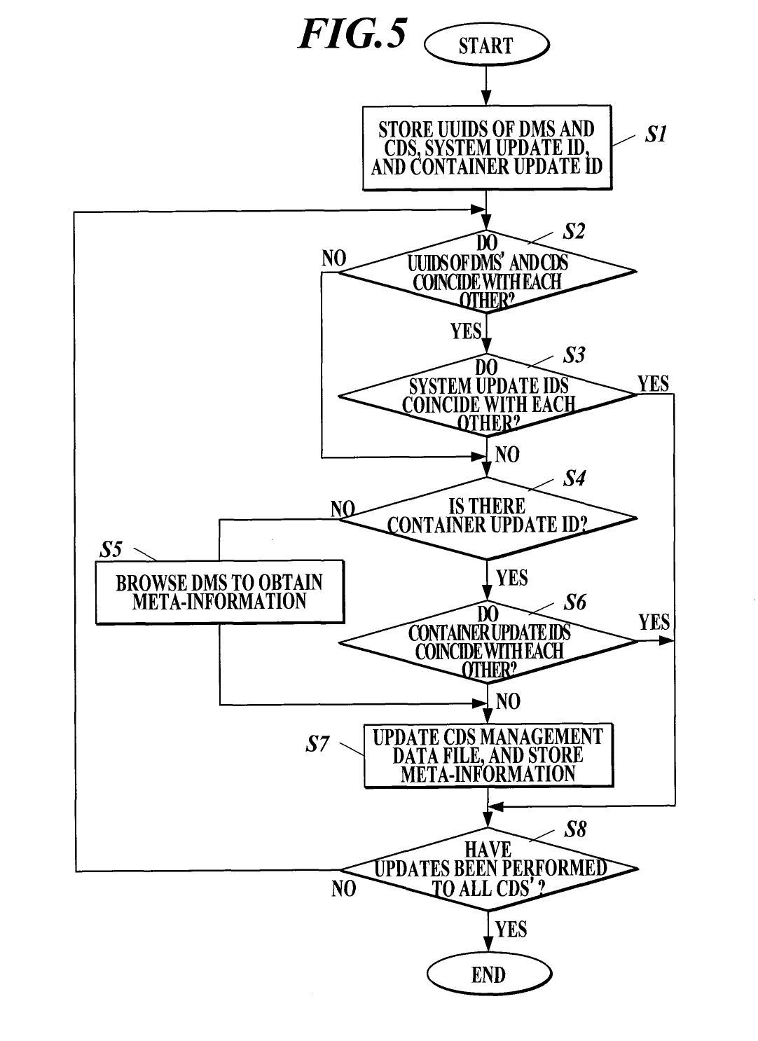

Next, a meta-information storing operation of one of the client terminals 2 in the client server system 100 having the configuration mentioned above is described with reference to the flow chart shown in FIG. 5.

The CPU 11 first obtains the UUIDs of the DMSes 1 connected to the client terminal 2 through the wireless circuit N, the UUIDs of the CDS programs 6E to manage the pieces of meta-information stored in the DMSes 1, the system update IDs and the container update IDs from the DMSes 1, and temporarily stores the obtained IDs into the RAM 12, by executing the CDS management data obtaining program 13C at the time of power activation (Step S1).

Next, the CPU 11 judges whether one of the UUIDs of the DMSes 1 and the corresponding one of the UUIDs of the CDS programs 6E that have been obtained at the Step S1 coincide with one of the UUIDs of the DMSes 1 and one of the UUIDs of the CDS programs 6E that are stored in the CDS management data file 13A or not, respectively, by the execution of the UUID comparing program 13D (Step S2).

When the CPU 11 judges that the UUID of the DMS 1 and the UUID of the CDS program 6E that have been obtained at the Step S1 do not coincide with any of the UUIDs of the DMSes 1 and any of the UUIDs of the CDS programs 6E that are stored in the CDS management data file 13A, respectively, at the Step S2 (Step S2; No), the operation advances to Step S4.

When the CPU 11 judges that the UUID of the DMS 1 and the UUID of the CDS program 6E that have been obtained at the Step SI coincide with one of the UUIDs of the DMSes 1 and one of the UUIDs of the CDS programs 6E that are stored in the CDS management data file 13A at the Step S2 (Step S2; Yes), the CPU 11 judges whether the system update ID that is managed by the CDS program 6E identified by the UUID and has been obtained from the DMS 1 identified by the UUID at the Step S1 coincide with any of the system update IDs stored in the CDS management data file 13A or not, by executing the update detecting program 13E (Step S3).

When the CPU 11 judges that the system update ID that has been obtained at the Step S1 coincides with one of the system update IDs stored in the CDS management data file 13A at the Step S3 (Step S3; Yes), the operation advances to Step S8.

When the CPU 11 judges that the system update ID that has been obtained at the Step S1 does not coincide with any of the system update IDs stored in the CDS management data file 13A at the Step S3 (Step S3; No), the CPU 11 judges whether any container update ID is stored in the DMS 1 or not by executing the browsing program 13F (that is, whether the container update ID of the DMS 1 has been obtained at the Step S1 or not) (Step S4).

When the CPU 11 judges that the container update ID is not stored in the DMS 1 at the Step S4 (Step S4; No), the CPU 11 performs the CDS browsing of the DMS 1 to obtain meta-information by executing the browsing program 13F (Step S5), and the operation thereof advances to Step S7.

When the CPU 11 judges that the container update ID is stored in the DMS 1 at the Step S4 (Step S4; Yes), the CPU 11 judges whether the container update ID that has been obtained at the Step S coincides with any of the container update IDs stored in the CDS management data file 13A or not by executing the container update ID comparing program 13G (Step S6).

When the CPU 11 judges that the container update ID that has been obtained at the Step S1 coincides with one of the container update IDs stored in the CDS management data file 13A at the Step S6 (Step S6; Yes), the operation of the CPU 11 advances to the Step S8.

When the CPU 11 judges that the container update ID that has been obtained at the Step S1 does not coincide with any of the container update IDs stored in the CDS management data file 13A at the Step S6 (Step S6; No), the CPU 11 updates the CDS management data file 13A on the basis of the UUID of the DMS 1 after update, the UUID of the CDS program 6E after update, the system update ID, and the container update ID, and obtains the updated meta-information from the DMS 1 to update the database 13B by executing the meta-information storing program 13H (Step S7).

Next, the CPU 11 judges whether the storage processing from the Step S2 to the Step S7 has been executed to the CDS programs 6E specified by all the UUIDs that have been obtained at the Step S1 or not (Step S8).

When the CPU 11 judges that the CPU 11 has not executed the storage processing from the Step S2 to the Step S7 to the meta-information managed by the CDS programs 6E specified by all the UUIDs that have been obtained at the Step S1 at the Step S8 (Step S8; No), the operation of the CPU 11 returns to the Step S2.

When the CPU 11 judges that the CPU 11 has executed the storage processing from the Step S2 to the Step S7 to the meta-information managed by the CDS programs 6E specified by all the UUIDs that have been obtained at the Step S1 at the Step S8 (Step S8; Yes), the CPU 11 ends the present processing.

According to the client server system 100 described above, in each of the DMSes 1, the pieces of the meta-information of contents are stored in the meta-information database 6B, and the pieces of the meta-information stored in the meta-information database 6B are transmitted to the client terminals 2 by the communication section 3. In each of the client terminals 2, the pieces of the meta-information transmitted by the communication sections 3 is stored in the database 13B; the UUIDs of the CDS programs 6E to identify the CDS programs 6E to manage the pieces of the meta-information of the contents of the DMSes 1, and the system update IDs and the container update IDs as the update-related information related to the updates of the pieces of the meta-information managed by the CDS programs 6E are stored in the CDS management data file 13A; and the UUIDs of the CDS programs 6E related to the DMSes 1 connected to the client terminal 2 through the wireless circuit N, and the system update IDs and the container update IDs as the update-related information of the pieces of the meta-information stored in the DMSes 1 are obtained at the time of power activation by the execution of the CDS management data obtaining program 13C by the CPU 11; by the execution of the UUID comparing program 13D, the update detecting program 13E, the browsing program 13F, and the container update ID comparing program 13G by the CPU 11, the UUIDs of the CDS programs 6E, the system update IDs, and the container update IDs that have been obtained by the execution of the CDS management data obtaining program 13C, are compared with the UUIDs of the CDS programs 6E, the system update IDs, and the container update IDs that are stored in the CDS management data file 13A, respectively; and it is judged whether the meta-information has been updated or not; by the execution of the meta-information storing program 13H by the CPU 11, when it is judged that the meta-information has been updated by the execution of the UUID comparing program 13D, the update detecting program 13E, the browsing program 13F, and the container update ID comparing program 13G, the updated meta-information is obtained from the DMS 1 to store the meta-information, and the databases 13B are updated. Consequently, the meta-information related to the contents of the DMSes 1 can be stored on the side of the client terminals 2 in advance, and, for example, when a user wants to display the meta-information on a client terminal 2, only the thing required for the user is to display the previously stored meta-information. Consequently, the pieces of the meta-information can be efficiently processed in the client terminals 2.

Moreover, in each of the DMSes 1, contents are stored in the plurality of containers K, and the container update IDs indicating the numbers of times of the updates of the containers K are stored in the update information data file 6D as the update-related information. In each of the client terminals 2, the container update IDs are stored in the CDS management data file 13A as the update-related information; the container update IDs stored in the update information data file 6D are obtained by the execution of the CDS management data obtaining program 13C by the CPU 11; and it is judged whether the obtained container update IDs coincides with the container update IDs stored in the CDS management data file 13A or not by the execution of the container update ID comparing program 13G by the CPU 11. Thereby, it is judged whether the meta-information database 6B has been updated or not. Consequently, it is possible to ascertain whether the pieces of the meta-information has been updated or not to each of the containers K, and to store the pieces of the meta-information into the client terminal 2 more surely.

Moreover, the system update IDs to indicate the numbers of times of the updates of the DMSes 1 are stored in the update information data files 6D provided in the DMSes 1 as the update-related information; the system update IDs are stored in the CDS management data file 13A as the update-related information; the system update IDs stored in the update information data files 6D are obtained by the execution of the CDS management data obtaining program 13C by the CPU 11; it is judged whether the system update IDs obtained by the execution of the CDS management data obtaining program 13C coincide with the system update IDs stored in the CDS management data file 13A or not by the execution of a update detecting section by the CPU 11; and when it is judged that the both of the system update IDs do not coincide with each other, it is judged whether the container update IDs obtained by the execution of the CDS management data obtaining program 13C coincide with the container update IDs stored in the CDS management data file 13A or not. Consequently, it is possible to judge whether the meta-information has been updated or not to each of the DMSes 1 on the basis of the system update IDs first, and to judge whether the meta-information has been updated or not to each of the containers K only when it has been judged that the meta-information of a DMS 1 has been updated. Consequently, it can be more efficiently ascertained whether the meta-information has been updated or not.

Moreover, the UUIDs of the DMSes 1 are stored in the identification information data files 6C provided in the DMSes 1; the UUIDs of the DMSes 1 and the UUIDs of the CDS programs 6E are stored in the state of being associated with each other in the CDS management data file 13A; the UUIDs related to the DMSes 1 connected with the client terminal 2 through the wireless circuit N are obtained by the execution of the CDS management data obtaining program 13C by the CPU 11; the CDS program 6E is specified on the basis of the UUID of the DMS 1 and the UUID of the CDS program 6E that has been obtained is managed by the specified CDS program 6E by the execution of the CDS management data obtaining program 13C by the execution of the UUID comparing program 13D by the CPU 11; and it is judged whether the container update IDs that have been obtained by the execution of the CDS management data obtaining program 13C coincide with the container update IDs stored in the CDS management data file 13A or not. Consequently, even if a plurality of CDS programs 6E is provided in each of the DMSes 1, or even if the meta-information of a plurality of DMSes 1 is managed by one CDS program 6E, then the CDS programs 6E can be specified, and the updates of the meta-information managed by the CDS programs 6E can surely be ascertained.

Incidentally, in the present embodiment, although the time of the power activation has been exemplified to be described as the predetermined timing when the client terminal 2 obtains the UUIDs of the DMSes 1, the UUIDs of the CDS programs 6E, the system update IDs, and the container update IDs from the DMSes 1 to update the meta-information, the timing is not limited to that time. The timing may be, for example, the time when a new DMS 1 is found in the wireless circuit N, or the time when the client terminal 2 receives the notice of an update of the system update ID and/or the container update ID from a DMS 1. For example, if a new DMS 1 is found in the wireless circuit N, only the thing required for the client terminal 2 is to perform the processing from the Step S2 to the Step S7 of FIG. 5. Moreover, if the client terminal 2 receives the notice of the update of the system update ID and/or the container update ID from the DMS 1, only the thing required for the client terminal 2 is to perform the processing from the Step S3 to the Step S6 of FIG. 5.

Moreover, although the present embodiment adopts the configuration in which the DMSes 1 manage the internal CDSes, a CDS management device to manage the CDSes of a plurality of DMSes in a lump may separately be provided. In this case, the UUIDs of the DMSes and the CDSes, the system update IDs, and the container update IDs may be transmitted from the CDS management device to the client terminal.

According to a first aspect of the preferred embodiments of the present invention, there is provided a client server system, comprising at least one server to store contents, and a client terminal connected to the at least one server through a wireless circuit to receive the contents from the at least one server, wherein

the at least one server includes:

a plurality of containers to store the contents;

a first storage section to store pieces of meta-information of the contents;

a container update information storing section to store container update information indicating numbers of times of updates of the containers;

a server update information storing section to store server update information indicating a number of times of updates of the at least one server;

a server identifying information storing section to store server identifying information to identify the server; and

a transmission section to transmit the pieces of the meta-information stored in the first storage section to the client terminal, and

the client terminal includes:

a second storage section to store the pieces of the meta-information transmitted by the transmission section;

a judgment information storing section to store the server identifying information, CDS identifying information to identify a CDS to manage the pieces of the meta-information of the contents of the at least one server, and the container update information and the server update information as update-related information related to updates of the meta-information managed by the CDS;

an obtainment section to obtain, at a time of power activation, the CDS identifying information related to the at least one server connected to the client terminal through the wireless circuit, the server identifying information, and the container update information and the server update information as update-related information of the pieces of the meta-information stored in the at least one server;

an update judging section to specify the CDS based upon the server identifying information and the CDS identifying information, which have been obtained by the obtainment section, to judge whether the server update information, which is managed by the specified CDS and has been obtained by the obtainment section, coincides with the server update information which has been stored in the judgment information storing section or not, to judge, when judged as not coinciding with each other, whether the container update information obtained by the obtainment section coincides with the container update information which has been stored in the judgment information storing section or not, thereby to judge whether the pieces of the meta-information have been updated or not; and

an update section to obtain updated pieces of meta-information from a server, which stores the updated pieces of the meta-information, of the at least one server to update the second storage section when the update judging section judges that the pieces of the meta-information have been updated.

According to the first aspect of the preferred embodiments, in the at least one server, the pieces of the meta-information of the content are stored in the first storage section, and the pieces of the meta-information stored in the first storage section are transmitted to the client terminal by the transmission section. In the client terminal, the pieces of the meta-information transmitted by the transmission section are stored in the second storage section; the CDS identifying information to identify the CDS to manage the pieces of the meta-information of the contents of the at least one server and the update-related information related to the updates of the pieces of the meta-information managed by the CDS are stored in the judgment information storing section; the CDS identifying information related to the at least one server connected to the client terminal through the wireless circuit and the update-related information of the meta-information stored in the at least one server are obtained by the obtainment section at the time of the power activation; the CDS identifying information and the update-related information that have been obtained by the obtainment section are compared with the CDS identifying information and the update-related information that are stored in the judgment information storing section, respectively, by the update judging section; whether the pieces of the meta-information have been updated or not is thereby judged; and when it is judged that the pieces of the meta-information have been updated by the update judging section, the pieces of the updated meta-information are obtained from the server storing the meta-information and the second storage section is updated by the update section. Consequently, the pieces of the meta-information related to the contents of the server can be stored in advance on the client terminal side. For example, if a user wants to display the pieces of the meta-information on the client terminal, only the thing required for the user is to display the pieces of the meta-information stored in advance, and the pieces of the meta-information can efficiently be processed in the client terminal.

Moreover, in the at least one server, the contents are stored by the plurality of containers, and the container update information to indicate the numbers of times of the updates of the containers is stored in the container update information storing section as the update-related information. In the client terminal, the container update information is stored in the judgment information storing section as the update-related information; the container update information stored in the container update information storing section is obtained by the obtainment section; and it is judged whether the container update information obtained by the obtainment section coincides with the container update information stored in the judgment information storing section or not by the update judging section. It is thereby judged whether the first storage section has been updated or not. Consequently, it can be ascertained whether the pieces of the meta-information have been updated or not with respect to container by container, and the pieces of the meta-information can be stored in the client terminal more surely.

Moreover, the server update information to indicate the number of times of the updates of a server is stored in the server update information storing section provided in the server as the update-related information; the server update information is stored in the judgment information storing section as the update-related information; the server update information stored in the server update information storing section is obtained by the obtainment section; and it is judged whether the server update information obtained by the obtainment section coincides with the server update information stored in the judgment information storing section or not by the update judging section. When it is judged as not coinciding with each other, it is judged whether the container update information obtained by the obtainment section coincides with the container update information which has been stored in the judgment information storing section or not. Consequently, it is first judged whether the meta-information has been updated or not to each server on the basis of the server update information, and it can be judged whether the pieces of the meta-information have been updated or not with respect to container by container only when it is judged that the meta-information in the server has been updated. Consequently, the update of the meta-information can be ascertained more efficiently.

Moreover, the server identifying information of a server is stored in the server identifying information storing section provided in the server; the server identifying information is stored in the judgment information storing section in the state of being associated with the CDS identifying information; the server identifying information related to the server connected with the client terminal through the wireless circuit is obtained by the obtainment section; the CDS is specified by the update judging section on the basis of the server identifying information and the CDS identifying information that have been obtained by the obtainment section; and it is judged whether the container update information that is managed by the specified CDS and has been obtained by the obtainment section coincides with the container update information stored in the judgment information storing section or not. Consequently, even if a plurality of CDSes are provided in the server, or even if the pieces of the meta-information of a plurality of servers is managed by one CDS, then the one CDS can be specified, and the updates of the meta-information managed by the CDS can surely be ascertained.

According to a second aspect of the preferred embodiments of the present invention, there is provided a client server system comprising at least one server to store contents, and a client terminal connected to the server through a wireless circuit to receive the contents from the at least one server, wherein

the at least one server includes:

a first storage section to store pieces of meta-information of the contents; and

a transmission section to transmit the pieces of the meta-information stored in the first storage section to the client terminal, and

the client terminal includes:

a second storage section to store the pieces of the meta-information transmitted by the transmission section;

a judgment information storing section to store CDS identifying information to identify a CDS to manage the pieces of the meta-information of the contents of the at least one server and update-related information related to updates of the pieces of the meta-information managed by the CDS;

an obtainment section to obtain, at a predetermined timing, CDS identifying information related to the at least one server connected to the client terminal through the wireless circuit and update-related information of the meta-information stored in the at least one server;

an update judging section to judge whether the pieces of the meta-information have been updated or not by comparing the CDS identifying information and the update-related information that have been obtained by the obtainment section with the CDS identifying information and the update-related information that have been stored in the judgment information storing section; and

an update section to obtain updated pieces of meta-information from a server, which stores the updated pieces of the meta-information, of the at least one server to update the second storage section when the update judging section judges that the pieces of the meta-information have been updated.

According to the second aspect of the preferred embodiments, in the at least one server, the pieces of the meta-information of the contents are stored in the first storage section, and the pieces of the meta-information stored in the first storage section are transmitted to the client terminal by the transmission section. In the client terminal, the pieces of the meta-information transmitted by the transmission section are stored in the second storage section; the CDS identifying information to identify the CDS to manage the pieces of the meta-information of the contents of the at least one server and the update-related information related to the updates of the pieces of the meta-information managed by the CDS are stored in the judgment information storing section; the CDS identifying information related to the at least one server connected to the client terminal through the wireless circuit and the update-related information of the pieces of the meta-information stored in the at least one server are obtained by the obtainment section at the predetermined timing; the CDS identifying information and the update-related information that have been obtained by the obtainment section are compared with the CDS identifying information and the update-related information that are stored in the judgment information storing section, respectively, by the update judging section; and it is thereby judged whether the pieces of the meta-information have been updated or not. When it is judged that the pieces of the meta-information have been updated by the update judging section, the updated pieces of the meta-information are obtained from the server to store the updated pieces of the meta-information, and the second storage section is updated by the update section. Consequently, the pieces of the meta-information related to contents of the at least one server can be stored on the client terminal side in advance. For example, when a user wants to display the pieces of the meta-information on the client terminal, only the thing required for the user is to display the previously stored pieces of the meta-information, and the pieces of the meta-information can efficiently be processed in the client terminal.

According to a third aspect of the preferred embodiments of the present invention, there is provided a client server system according to the second aspect, wherein

the at least one server includes:

a plurality of containers to store the contents; and

a container update information storing section to store container update information indicating numbers of times of updates of the containers as the update-related information, and

the judgment information storing section stores the container update information as the update-related information;

the obtainment section obtains the container update information stored in the container update information storing section; and

the update judging section judges whether the first storage section has been updated or not by judging whether the container update information which has been obtained by the obtainment section coincides with the container update information which has been stored in the judgment information storing section or not.

According to the third aspect of the preferred embodiments, it is a matter of course that the advantages similar to those of the second aspect can be obtained. In particular, in the at least one server, the contents are stored in the plurality of containers, and the container update information to indicate the numbers of times of the updates of the containers is stored in the container update information storing section as the update-related information. In the client terminal, the container update information is stored in the judgment information storing section as the update-related information; the container update information stored in the container update information storing section is obtained by the obtainment section; and it is judged whether the container update information obtained by the obtainment section coincides with the container update information stored in the judgment information storing section or not by the update judging section. It is thereby judged whether the first storage section has been updated or not. Consequently, it can be ascertained with respect to container by container whether the pieces of the meta-information have been updated or not, and the pieces of the meta-information can be stored in the client terminal more surely.

According to a fourth aspect of the preferred embodiments of the present invention, there is provided a client server system according to the third aspect, wherein

the at least one server includes a server update information storing section to store server update information indicating a number of times of updates of the at least one server as the update-related information,

the judgment information storing section stores the server update information as the update-related information,

the obtainment section obtains the server update information stored in the server update information storing section, and

the update judging section judges whether the server update information which has been obtained by the obtainment section coincides with the server update information which has been stored in the judgment information storing section or not, and when judged as not coinciding with each other, judges whether the container update information which has been obtained by the obtainment section coincides with the container update information which has been stored in the judgment information storing section.

According to the fourth aspect of the preferred embodiments, it is a matter of course that the advantages similar to those of the third aspect can be obtained. In particular, the server update information to indicate the number of times of the updates of the server is stored in the server update information storing section provided in the at least one server as the update-related information; the server update information is stored in the judgment information storing section as the update-related information; the server update information stored in the server update information storing section is obtained by the obtainment section; and it is judged whether the server update information obtained by the obtainment section coincides with the server update information stored in the judgment information storing section or not by the update judging section. When it is judged that both kinds of the server update information do not coincide with each other, it is judged whether the container update information obtained by the obtainment section coincides with the container update information stored in the judgment information storing section or not. Consequently, it is first judged whether the pieces of the meta-information have been updated or not with respect to server by server on the basis of the server update information, and it can be judged whether the pieces of the meta-information have been updated or not with respect to container by container only when it is judged that the pieces of the meta-information in the server have been updated. Consequently, the update of the pieces of the meta-information can be ascertained more efficiently.

According to a fifth aspect of the preferred embodiments of the present invention, there is provided a client server system according to the third aspect, wherein

the at least one server includes a server identifying information storing section to store server identifying information to identify the server,

the judgment information storing section stores the server identifying information and the CDS identifying information in a state of associating them with each other,

the obtainment section obtains server identifying information related to the at least one server connected to the client terminal through the wireless circuit, and

the update judging section specifies the CDS based upon the server identifying information and the CDS identifying information that have been obtained by the obtainment section, and judges whether the container update information that is managed by the specified CDS and has been obtained by the obtainment section coincides with the container update information that have been stored in the judgment information storing section or not.

According to the fifth aspect of the preferred embodiments, it is a matter of course that the advantages similar to those of the third aspect can be obtained. In particular, the server identifying information of the at least one server is stored in the server identifying information storing section provided in the at least one server; the server identifying information is stored in the judgment information storing section in the state of being associated with the CDS identifying information; the server identifying information related to the at least one server connected to the client terminal through the wireless circuit is obtained by the obtainment section; the CDS is specified by the update judging section on the basis of the server identifying information and the CDS identifying information that have been obtained by the obtainment section; and it is judged whether the container update information that is managed by the specified CDS and has been obtained by the obtainment section coincides with the container update information stored in the judgment information storing section or not. Consequently, even if the plurality of CDSes are provided in one of the at least one server, or even if the pieces of the meta-information of the plurality of servers are managed by one CDS, the CDS can be specified, and the updates of the pieces of the meta-information managed by the CDS can surely be ascertained.

The entire disclosure of Japanese Patent Application No. 2006-284173 filed on Oct. 18, 2006 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A client server system, comprising at least one server to store contents, and a client terminal connected to the at least one server through a wireless circuit to receive the contents from the at least one server, wherein
the at least one server includes:
a plurality of containers to store the contents;
a first storage section to store pieces of meta-information of the contents;
a container update information storing section to store container update information indicating numbers of times of updates of the containers;
a server update information storing section to store server update information indicating a number of times of updates of the at least one server;
a server identifying information storing section to store server identifying information to identify the server; and
a transmission section to transmit the pieces of the meta-information stored in the first storage section to the client terminal, and
the client terminal includes:
a second storage section to store the pieces of the meta-information transmitted by the transmission section;
a judgment information storing section to store the server identifying information, CDS identifying information to identify a CDS to manage the pieces of the meta-information of the contents of the at least one server, and the container update information and the server update information as update-related information related to updates of the meta-information managed by the CDS;
an obtainment section to obtain, at a time of power activation, the CDS identifying information related to the at least one server connected to the client terminal through the wireless circuit, the server identifying information, and the container update information and the server update information as update-related information of the pieces of the meta-information stored in the at least one server;
an update judging section to specify the CDS based upon the server identifying information and the CDS identifying information, which have been obtained by the obtainment section, to judge whether the server update information, which is managed by the specified CDS and has been obtained by the obtainment section, coincides with the server update information which has been stored in the judgment information storing section or not, to judge, when judged as not coinciding with each other, whether the container update information obtained by the obtainment section coincides with the container update information which has been stored in the judgment information storing section or not, thereby to judge whether the pieces of the meta-information have been updated or not; and
an update section to obtain updated pieces of meta-information from a server, which stores the updated pieces of the meta-information, of the at least one server to update the second storage section when the update judging section judges that the pieces of the meta-information have been updated.

2. A client server system comprising at least one server to store contents, and a client terminal connected to the server through a wireless circuit to receive the contents from the at least one server, wherein
the at least one server includes:
a first storage section to store pieces of meta-information of the contents; and
a transmission section to transmit the pieces of the meta-information stored in the first storage section to the client terminal, and
the client terminal includes:
a second storage section to store the pieces of the meta-information transmitted by the transmission section;
a judgment information storing section to store CDS identifying information to identify a CDS to manage the pieces of the meta-information of the contents of the at least one server and update-related information related to updates of the pieces of the meta-information managed by the CDS;
an obtainment section to obtain, at a predetermined timing, CDS identifying information related to the at least one server connected to the client terminal through the wireless circuit and update-related information of the meta-information stored in the at least one server;
an update judging section to judge whether the pieces of the meta-information have been updated or not by comparing the CDS identifying information and the update-related information that have been obtained by the obtainment section with the CDS identifying information and the update-related information that have been stored in the judgment information storing section; and
an update section to obtain updated pieces of meta-information from a server, which stores the updated pieces of the meta-information, of the at least one server to update the second storage section when the update judging section judges that the pieces of the meta-information have been updated.

3. The client server system according to claim 2, wherein
the at least one server includes:
a plurality of containers to store the contents; and
a container update information storing section to store container update information indicating numbers of times of updates of the containers as the update-related information, and
the judgment information storing section stores the container update information as the update-related information;
the obtainment section obtains the container update information stored in the container update information storing section; and
the update judging section judges whether the first storage section has been updated or not by judging whether the container update information which has been obtained by the obtainment section coincides with the container update information which has been stored in the judgment information storing section or not.

4. The client server system according to claim 3, wherein
the at least one server includes a server update information storing section to store server update information indicating a number of times of updates of the at least one server as the update-related information,
the judgment information storing section stores the server update information as the update-related information,
the obtainment section obtains the server update information stored in the server update information storing section, and
the update judging section judges whether the server update information which has been obtained by the obtainment section coincides with the server update information which has been stored in the judgment information storing section or not, and when judged as not coinciding with each other, judges whether the container update information which has been obtained by the obtainment section coincides with the container update information which has been stored in the judgment information storing section.

5. The client server system according to claim 3, wherein
the at least one server includes a server identifying information storing section to store server identifying information to identify the server,
the judgment information storing section stores the server identifying information and the CDS identifying information in a state of associating them with each other,
the obtainment section obtains server identifying information related to the at least one server connected to the client terminal through the wireless circuit, and
the update judging section specifies the CDS based upon the server identifying information and the CDS identifying information that have been obtained by the obtainment section, and judges whether the container update information that is managed by the specified CDS and has been obtained by the obtainment section coincides with the container update information that have been stored in the judgment information storing section or not.
